(19) United States
(12) Patent Application Publication
(10) Pub. No.: US 2024/0321143 A1
(43) Pub. Date: Sep. 26, 2024

(54) ANNULAR CELESTIAL DISPLAY

(71) Applicant: Brandon Scott Hansen, Taylorsville, UT (US)

(72) Inventor: Brandon Scott HANSEN, Taylorsville, UT (US)

(21) Appl. No.: 18/614,447

(22) Filed: Mar. 22, 2024

Related U.S. Application Data
(60) Provisional application No. 63/454,313, filed on Mar. 24, 2023.

(51) Int. Cl. G09B 27/06

(52) U.S. Cl. CPC G09B 27/06

(57) ABSTRACT

A celestial display comprises a board and a plurality of position indicators arranged thereon, including (i) a star position indicator, (ii) a planet position indicator representing a planet that orbits a star represented by the star position indicator, and (iii) a plurality of orbit position indicators arranged around the planet position indicator that each represent a phase of a moon that orbits the planet. The planet position indicator and the star position indicator are arranged along a bisector line of the board and offset from a rotation axis of the board in opposite directions. Rotational positions of the board are each associated with a respective time of day relative to the planet, and, for each rotational position of the board, each of the plurality of orbit position indicators indicates a respective position of the moon relative to an observer on the planet at the respective time of day.

### CROSS-REFERENCE TO RELATED APPLICATIONS

This application claims priority to U.S. Provisional Patent Application No. 63/454,313, filed on Mar. 24, 2023, and entitled “Annular Celestial Display”, the entirety of which is incorporated herein by reference for all purposes.

### BACKGROUND

Humans have built technology and designed tools to display the movements of the celestial plane since time immemorial. Many kinds of celestial displays are used by scientists, astronomers, and teachers who study and educate others on the properties and mechanics of objects in space. Various types of celestial displays are also used by stargazers who observe the sky as a hobby, as well as by metaphysicians (e.g., astrologers) who pontificate on the archetypal meanings correlated to planetary alignments and stellar events.

The subject matter described and/or claimed herein is not limited to embodiments that operate only in environments or contexts such as those described above. Rather, this background is only provided to illustrate one exemplary technology area where some embodiments described herein may be practiced.

### BRIEF DESCRIPTION OF THE DRAWINGS

References will be made to embodiments of the disclosure, examples of which may be illustrated in the accompanying figures. These figures are intended to be illustrative, not limiting. Although the disclosure is generally described in the context of these embodiments, it should be understood that it is not intended to limit the scope of the disclosure to these particular embodiments. Items in the figures are not necessarily drawn to scale.

FIG. 1 illustrates an example outside-in side of an Annular Celestial Display, in accordance with implementations of the disclosed subject matter.

FIG. 2 illustrates an Annular Celestial Display system that includes an outside-in side of an Annular Celestial Display, an earth object, a sun object, and a moon object, which are set up to depict a particular moment in space-time, in accordance with implementations of the disclosed subject matter.

FIG. 3 illustrates an example inside-out side of an Annular Celestial Display, in accordance with implementations of the disclosed subject matter.

FIG. 4 illustrates an Annular Celestial Display system that includes an inside-out side of an Annular Celestial Display, an earth object, a sun object, and a moon object, which are set up to depict a particular moment in space-time, in accordance with implementations of the disclosed subject matter.

FIG. 5 illustrates another embodiment of an outside-in side of an Annular Celestial Display, in accordance with implementations of the disclosed subject matter.

FIG. 6 illustrates an Annular Celestial Display system that includes an outside-in side of an Annular Celestial Display and various objects representing different celestial bodies, which are set up to depict a theoretical moment, in accordance with implementations of the disclosed subject matter.

FIG. 7 illustrates another embodiment of an outside-in side of an Annular Celestial Display, in accordance with implementations of the disclosed subject matter.

FIG. 8 illustrates another embodiment of an outside-in side of an Annular Celestial Display, in accordance with implementations of the disclosed subject matter.

FIG. 9 illustrates another embodiment of an inside-out side of an Annular Celestial Display, in accordance with implementations of the disclosed subject matter.

FIG. 10 illustrates another embodiment of an inside-out side of an Annular Celestial Display, in accordance with implementations of the disclosed subject matter.

### DETAILED DESCRIPTION

Disclosed embodiments are directed to an Annular Celestial Display (which is also referred to herein as a “celestial display” or simply an “Annulus”).

As noted above, various tools and methods have been developed over time to represent celestial objects. For example, star charts or maps have been drawn by astronomers in nearly every culture since antiquity, from cave drawings in Europe, to stone tablets in Mesopotamia, to decorative boxes in China. This technology was used by travelers navigating over land or sea at night. Improvements have been made to star charts or maps through history. For example, etching the representation of the sky into wood allowed for the first printed maps, and the development of paper allowed maps to become more accessible and portable. Modernly, the planisphere makes star-charts much more useful by depicting more clearly which stars can be seen during certain times of certain nights of the year. Star-charts very often connect the stars together into constellations or asterisms through lines, images, and names, which can project a sense of the cultural paradigm onto the record of the sky. Being fixed images, star charts rarely depict the moving planets. Sometimes star-maps do show celestial viewpoints, such as a heliocentric view of the solar system, but they do not typically allow a user to set up a representation focused on a specific moment in time (instead only providing an annual representation).

As another example, the Tal-Qadi Sky Tablet is a 4500 year old piece of stone, discovered on the island of Malta. It displays a few important asterisms, such as the Pleiades and Hyades, also known as the Golden Gate of the Ecliptic, which allows the user to calculate multiple cycles by measuring how the moon passed through that space month after month. It displays only this limited space of a few stars along the ecliptic.

As an additional example, the sundial or shadow clock represents one of the first clocks, the oldest example being from Egypt, likely made around 150 BC. Most variations are a combination of a base with hours marked upon it, and a “Gnomon”, which displays the local time of day when the Sun shines upon it and casts a shadow onto the base. Sundials cannot function correctly if oriented in the wrong direction, if placed inside, or when the sun is occluded (e.g., by clouds). Sundials also fail to relate any celestial position besides that of the sun.

As yet another example, the Pinax was an ancient board, used by Hellenistic-era astrologers to display the alignments of the planets, by placing stones in 12 sections, representing the 12 zodiacal signs. The boards displayed many symbols, images, and words that made them useful in a culturally specific context. They were geocentric, with the Earth displayed or understood to be in the center. A Pinax could be made of marble, representing the most opulent versions of a horoscope, but they could also be drawn on a piece of parchment, or even in sand.

As still another example, the Antikythera Mechanism is regarded as the oldest analog computer, likely constructed around 100 BC. Restoration has shown it contained gears and a crank to display the true movements of the planets through the sky and calculate eclipses, Olympic games, and other cycles. The Antikythera Mechanism was geocentric as well, and its crank mechanism allowed it to show linear movements through time, making it difficult to render a specific moment of time. The Antikythera Mechanism was also incredibly complicated and costly to construct (even for modern artisans).

More recently, the orrery was designed to display the orbits of the planets from a heliocentric point-of-view. Orreries can take on many forms, ranging from hand-held to room-sized implementations. Orreries have similar restrictions to the Antikythera Mechanism, but often cannot be set to display the true alignments of a specific moment, showing more theoretical celestial orbits.

In modern times, computer systems can be finely tuned and manipulated to capture moments of space-time in exquisite detail and can render many different viewpoints. However, computer systems rely on a power supply to perform computations and can lack the tangible and tactile aspect needed for many to learn what is being represented.

In educational domains, teachers have access to several displays of the solar system, but most of these are theoretical, with limited teaching potential. For instance, some models (e.g., tactile models, hanging mobiles, posters, mats) only depict how the solar system is organized by distance from the sun, through a single, static configuration.

Stargazers have relied on 2-dimensional maps (similar to the planispheres discussed above) and optics-based tools such as binoculars and telescopes to perceive and gain familiarity with celestial objects. More recently, applications for mobile electronic devices (e.g., smartphones, tablets, etc.) have been developed to help stargazers find and recognize various celestial objects. However, such tools can fail to provide users with a tangible, manipulable representation of celestial objects and/or moments in time.

Industry-standard tools for astrologers include 2-dimensional charts and tables, which are usually either rendered on a computer program, or upon paper (printed or hand-drawn). While extremely cheap and easy to create, neither of these variations are particularly tangible, which reduces the ability for both astrologer and querent to visualize and understand the alignments. Some physical displays of astrology charts have been produced, but they do little to take advantage of the medium, and simply display on a board or table the same 2-dimensional configuration of a circle chart.

Commemorative art pieces have developed as a modality for depicting moments of time of celestial objects, such as those showing the arrangement of the stars in a night sky on an anniversary (or other special event) or jewelry (or other medium of expression) showing the phase of the moon on a birthday (or other special event). Such sentimental representations are limited in their capacity by only showing one specific moment of time, and having little use besides decoration.

The principles disclosed herein may be implemented to provide a physical display upon which specific moments of space-time can be displayed accurately and easily.

In one example, an Annular Celestial Display utilizes circles in its design, such as by implementing a disk-shaped board with circular divots engraved upon one or more of its surfaces. The divots may be arranged in a way that allows the display of planetary alignments in past, future, or hypothetical times. Additionally, or alternatively, users may utilize an Annular Celestial Display to follow along with planetary alignment cycles in present moments. Utilizing an Annular Celestial Display, as described herein, can enable astronomy to be better understood, taught, and interacted with by various types of users in various types of domains (e.g., students and teachers in educational contexts, stargazers, astronomers, astrologers, and/or others).

An Annular Celestial Display may be implemented as a circular board or disk (or a board of another shape) made of any material of a suitable thickness. An Annulus may be engraved or affixed with a plurality of divots. The divots may be used to plot the locations of celestial objects like stars, planets, etc. In some embodiments, the divots are adapted to receive/hold actual three-dimensional tangible objects (e.g., spherical objects) on the surface of the Annulus (e.g., in a manner that prevents displacement of the objects during rotation of the Annulus). Such a configuration can contribute to the accuracy of rendering objects with enough mass to reach hydrostatic equilibrium, where its own gravity pulls its mass into a spherical shape, which constitutes many major celestial objects visible to the eye in astronomy. A single Annular Celestial Display may enable multiple perspectives by engraving the disk or board on both sides. In some instances, an Annulus is light and/or small enough to flip over manually (or by an actuation/rotation mechanism).

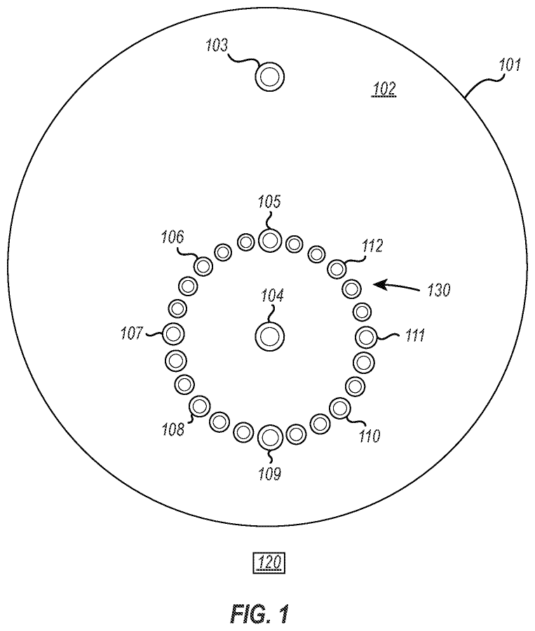

As shown in FIG. 1, an Annular Celestial Display 102 may include a circular border 101 and a plurality of divots (or other types of position indicators). Such divots can represent a star and a planet and can be referred to, respectively, as a star divot and a planet divot. For instance, one divot may represent the sun (labeled in FIG. 1 as the sun divot 103), and one divot may represent the earth (labeled in FIG. 1 as the earth divot 104) (or another planet). In the example shown in FIG. 1, the earth divot 104 and the sun divot 103 are arranged along a bisector line of the Annular Celestial Display 102 (e.g., a line of symmetry or diameter line in the case of the circular Annular Celestial Display 102) and on opposing sides of a center (or rotational axis) of the Annular Celestial Display 102. The divots may comprise different sizes (e.g., with the divot representing the more massive and bright star being larger, and with the divot representing the smaller planet being smaller). The divots of an Annular Celestial Display 102 can be configured to receive spheres or other objects representing respective celestial objects (e.g., the sun divot 103 can be configured to receive and retain a sphere or other object representing the sun, and the earth divot 104 can be configured to receive and retain a sphere or other object representing the earth).

Continuing with the example where one divot of the Annular Celestial Display 102 represents the earth (i.e., the earth divot 104) and another divot represents the sun (i.e., the sun divot 103), a user, facing the Annular Celestial Display 102, may turn/arrange the Annular Celestial Display 102 into different rotational configurations to cause the Annular Celestial Display 102 to represent different positions of the sun and the earth at different times. For example, the user may rotate the Annular Celestial Display 102 so that the earth divot 104 is closest to the user and the sun divot 103 is furthest from the user. Such a position is shown in FIG. 1, with position 120 representing the position of the user. The rotational configuration shown in FIG. 1 may represent noon, or midday, when the sun has culminated at its highest point. From such a configuration/position, the Annular Celestial Display 102 may be rotated clockwise, enabling the Annular Celestial Display 102 to represent time similar to a clock, with the descending sun divot 103 becoming positioned rightward from the earth divot 104 (with respect to the user facing the Annular Celestial Display 102 and fixed at position 120) to represent the setting sun (e.g., in the west) (e.g., moving past positions corresponding to 1 pm, 2 pm, 3 pm, etc.). The relative positioning of the sun divot 103 and the earth divot 104 may represent a 24-hour duration, with continued clockwise rotation of the Annular Celestial Display 102 representing further setting of the sun until a midnight position is reached with the sun divot 103 being positioned closest to the user and the earth divot 104 being positioned furthest from the user (relative to fixed position 120), and with still further rotation of the Annular Celestial Display 102 from the midnight position representing rising of the sun with the rising sun divot 103 becoming positioned leftward from the earth divot 104 (with respect to the user facing the Annular Celestial Display 102 and fixed at position 120) until the noon position is again reached with the sun divot 103 positioned furthest from the position 120 of the user as shown in FIG. 1. According to the foregoing example, in some implementations, one clockwise rotation of an Annular Celestial Display 102 can represent the turning of the planet (e.g., the earth represented by the earth divot 104) on its axis, or one day (according to the time of the planet). The day can be visualized through the clockwise rotation of the Annular Celestial Display 102 itself, or by the user walking counter-clockwise around the Annular Celestial Display 102.

Continuing with another aspect of the example where one divot of the Annular Celestial Display 102 represents the earth (i.e., the earth divot 104) and another divot represents the sun (i.e., the sun divot 103), the user may rotate the Annular Celestial Display 102 so that the earth divot 104 is closest to the user and sun divot 103 is furthest from the user (as shown in FIG. 1, with position 120 representing the position of the user). Such a configuration can represent the northern solstice, where the sun reaches the Tropic of Cancer around June 20th. From such a configuration/position, the Annular Celestial Display 102 may be rotated counterclockwise to enable the Annular Celestial Display 102 to represent time similar to a calendar, with the descending sun divot 103 becoming positioned leftward from the earth divot 104 (with respect to the user facing the Annular Celestial Display 102 and fixed at position 120) to represent temporal movement through the northern summer months of July and August. The relative positioning of the sun divot 103 and the earth divot 104 may represent a calendar year, with continued counterclockwise rotation of the Annular Celestial Display 102 representing further temporal movement until a southern equinox position is reached (e.g., around September 20th) with the sun divot 103 arranged at a leftmost position and with the earth divot 104 arranged at a rightmost position (relative to fixed position 120), and with further counterclockwise rotation of the Annular Celestial Display 102 representing further temporal movement until a southern solstice position is reached (e.g., around December 20th) with the sun divot 103 being positioned closest to the user and with the earth divot 104 being positioned furthest from the user (relative to fixed position 120), and with further counterclockwise rotation of the Annular Celestial Display 102 representing further temporal movement until a vernal equinox position is reached (e.g., around March 20th) with the sun divot 103 arranged at a rightmost position and with the earth divot 104 arranged at a leftmost position (relative to fixed position 120), and with further counterclockwise rotation of the Annular Celestial Display 102 representing further temporal movement until returning to the northern solstice position (shown in FIG. 1). According to the foregoing example, in some implementations, one counterclockwise rotation of the Annular Celestial Display 102 can represent the orbit of the planet (e.g., the earth represented by the earth divot 104) around its star (e.g., the sun represented by the sun divot 103), or one year. The year can be visualized through the counterclockwise rotation of the Annular Celestial Display 102 itself, or by the user walking clockwise around the Annular Celestial Display 102.

An Annulus may include any number of divots, which may be arranged in any manner of patterns to show/represent various lunar-and/or planetary-orbits, and/or stellar contexts. Advantageously, divots of an Annulus may be utilized to represent such features while omitting lines or symbols, thereby providing a simplified interface for depicting aspects of astronomy, and reducing the cultural limitations that come from language, numbers, and other kinds of symbolism. This can make an Annulus universal, able to be utilized the same way around the world. It can also make the divots of an Annulus operate as a kind of braille, accessible to those who might need to learn tactically, instead of visually. The Annulus can thus make the sky accessible to those who can't see the real thing (e.g., for blind persons, for persons living in polluted or overcast areas, etc.).

Rotation of an Annulus may be achieved in various ways, such as by positioning the Annulus on a flat or smooth surface to permit sliding rotation of the Annulus, or by positioning the Annulus on a rotating surface (e.g., a turntable, a fluid bed). In some instances, an Annulus includes rotation features, such as a protrusion aligned with a rotational axis of the Annulus (e.g., the protrusion may be positioned on a surface of the Annulus that is opposite the surface being observed by users). In some embodiments, it is important for an Annulus to rotate because the things it depicts are perpetually rotating, themselves.

Although examples herein are focused, in at least some respects, on implementing divots on an Annulus to facilitate tracking and/or positioning of celestial objects/formations (and/or representations thereof, such as physical objects configured to be selectively positioned on the Annulus via the divots), an Annulus may employ other types of position indicators for such purposes, such as simple markings, magnetic elements, hook and loop fasteners, detents or protrusions (e.g., with corresponding to detents or protrusions on objects for placement on the Annulus), and/or other types of interlocking or otherwise corresponding interface features. In some instances, users can lay the Annulus horizontally on a flat surface, enabling gravitational forces to retain spheres (or other objects) within the divots, although creative design and accessories or circumstances could be utilized to enable the Annulus to retain objects in the divots thereof when positioned at an incline or other orientation. Furthermore, although examples provided herein focus on implementation of an Annulus on a board, an Annulus can be formed on any type of base (e.g., a table, floor, ground, or any surface), such as by placing position indicators or divots thereon to represent the positions of celestial objects as described herein.

As noted above, many conventional astronomy tools are designed with a perspective centered on a particular celestial body, such as a geocentric perspective or a heliocentric perspective. In some implementations, at least one side of an Annulus differs from such conventional designs by utilizing a perspective that is focused on a pair of celestial bodies, such as the earth and the sun as represented by the earth divot 104 and the sun divot 103 of the Annular Celestial Display 102 (or any other pair of celestial objects, whether in the solar system or not). In such implementations, the divots (or other position indicators) associated with the pair of celestial bodies are offset from the rotational axis (which may or may not be the center) of the Annulus, such that rotation of the Annulus causes movement of the divots (e.g., rotation of the divots about the center; movement of the divots relative to a stationary user that is not on the Annulus).

An Annulus may be constructed from any suitable material, such as wood, resin, metal, stone, plastic, cardboard, styrofoam and/or others.

In some instances, different sides of a single Annulus provide different perspectives for representing stellar systems. For instance, a first side of an Annulus may depict a system from a macro-cosmic perspective, as if the user were on the outside of the system and looking in or down upon the system, while a second side of the Annulus may depict a system from a micro-cosmic perspective, with the user looking out, or up from inside the system. As used herein, the first side of such an Annular embodiment is referred to as the Outside-In Side (OIS), and the second side is referred to as the Inside-Out Side (IOS).

The side of the Annular Celestial Display 102 shown in FIG. 1 can comprise an Outside-In Side. The OIS of the Annular Celestial Display 102 of FIG. 1 includes an additional divot arrangement 130 (or arrangement of position indicators or orbit position indicators) around the earth divot 104, representing the orbit of the earth's moon. The divots of the divot arrangement 130 can be configured to receive a sphere (or other object) representing the moon, and the sphere can be rotated to different divots of the divot arrangement 130 over time to track the orbiting of the moon about the earth (represented by the earth divot 104). The number of divots in this divot arrangement 130 can be correlated to the number of days in the moon's orbit or new moon cycle for ease of use (though the number can be intentionally adjusted for geometry or other purposes). The OIS of the example Annular Celestial Display 102 in FIG. 1 includes twenty-four divots in the divot arrangement 130 representing moon's orbit, which is a few less than the number of days in the moon's orbit or new moon cycle (e.g., 29 days). The configuration of the divot arrangement 130 with 24 divots can allow each consecutive divot to represent an even 15° of movement (e.g., which might be the preference for an astrologer or other individual valuing precise geometry). Other configurations for a divot arrangement 130 representing the orbit of a moon can be used (e.g., one divot per day in the new moon cycle, which can be beneficial for users valuing the practice of moving the moon to a different divot of the divot arrangement 130 daily, sacrificing symmetry for routine).

The relative position of each divot of the divot arrangement 130 representing the moon's orbit can display information about the phase and the times of day when and where the moon can be seen in the sky. For instance, divot 105 of the divot arrangement 130 representing the moon's orbit is positioned directly between the earth divot 104 (or planet divot more generally) and sun divot 103 (or star divot more generally) and can represent the position of a new moon (e.g., 0° from the sun or other star), when the moon cannot be seen at any time of day due to its shadowed side facing the earth (or other planet about which the moon orbits) and due to the sun's light being too bright to see anything too closely aligned therewith. Rotation of the Annular Celestial Display 102 in the clockwise direction (as described above) can enable divot 105 to visualize the rising, culmination, and setting of the new moon (represented by divot 105) at the same time as the sun (represented by the sun divot 103) from the perspective of the earth (represented by the earth divot 104). As another example, divot 109 of the divot arrangement 130 representing the moon's orbit is positioned on the opposite side of the earth divot 104 (or planet divot more generally) relative to the sun divot 103 (or star divot more generally) and can represent the position of a full moon (e.g., 180° from the sun or other star), when the moon is most bright (e.g., and visible all night) due to its lit side fully facing the earth (or other planet about which the moon orbits). Rotation of the Annular Celestial Display 102 in the clockwise direction (as described above) can cause divot 109 to visualize the rising of the full moon (represented by divot 109) at the setting of the sun (represented by the sun divot 103), the culminating of the full moon at midnight, and the setting of the full moon at the rising of the sun.

Other divots of the divot arrangement 130 can be used to visualize the positions of the waxing crescent moon (divot 106, 45° away from the sun represented by the sun divot 103), the first quarter moon (divot 107, at 90° away from the sun represented by the sun divot 103), the waxing gibbous moon (divot 108, 135° away from the sun represented by the sun divot 103), the waning gibbous moon (divot 110, 225° away from the sun represented by the sun divot 103), the third quarter moon (divot 111, 270° away from the sun represented by the sun divot 103), and the waning gibbous moon (divot 112, 315° away from the sun represented by the sun divot 103). When the moon is at divot 107 representing its first quarter, rotation of the Annular Celestial Display 102 in the clockwise direction (as described above) can enable visualization of the rising of the first quarter moon in the east at midday (e.g., the position shown in FIG. 1 relative to the fixed position 120), with the first quarter moon at divot 107 being positioned on the Annular Celestial Display 102 to the left of the earth divot 104 while the sun divot 103 is furthest from the user (at fixed position 120); continued clockwise rotation of the Annular Celestial Display 102 can enable visualization of the ascension of the first quarter moon through the afternoon, with the divot 107 being further than and to the left of the earth divot 104 (relative to a user at fixed position 120) while the sun divot 103 is further than and to the right of the earth divot 104 (relative to a user at fixed position 120); continued clockwise rotation of the Annular Celestial Display 102 can enable visualization of the culmination of the first quarter moon at the top of the sky at sunset, with the divot 107 being furthest from the user (at fixed position 120) while the sun divot 103 is at a rightmost position (relative to a user at fixed position 120); continued clockwise rotation of the Annular Celestial Display 102 can enable visualization of the descent of the first quarter moon in the western side of the nighttime sky in the evening, with the divot 107 being positioned further than and to the right of the earth divot 104 (relative to a user at fixed position 120) while the sun divot 103 is positioned closer than and to the right of the earth divot 104 (relative to a user at fixed position 120); continued clockwise rotation of the Annular Celestial Display 102 can enable visualization of the setting of the first quarter moon in the west at midnight, with the divot 107 reaching a rightmost position (relative to a user at fixed position 120) while the sun divot 103 is closest to the user (at fixed position 120). Such a visualization accomplished by rotation of the Annular Celestial Display 102 can be performed for any phase of the moon.

A “super full moon” may be represented on the Annular Celestial Display 102 by positioning a representation of the moon (e.g., a sphere or other object) exactly opposite the sun divot 103 (about the earth divot 104) and using an Annulet to indicate perigee by placing the representation of the moon closer to the earth divot 104 than divot 109 of the divot arrangement 130 representing the orbit of the moon. As used herein, an “Annulet” refers to a representation of a celestial object that is placed on an Annulus but that is not retained by a divot (or other fixed position indicator) of the Annulus. An Annulet can take on various forms, such as rings, disks, coins, cards, hoops, loops, objects placed on any of the foregoing, etc. The design of an Annulus, like many objects that attempt to display three-dimensional space on a two-dimensional surface, can, in some instances, be prone to inaccuracies and/or warping. For example, in the example Annular Celestial Display 102 shown in FIG. 1, the divot arrangement 130 represents the orbit of the moon as a circular orbit, which does not perfectly represent the elliptical orbit of the moon, where the moon is closest to the Earth at one point, called lunar perigee, and furthest at another, called lunar apogee. The lunar perigee and apogee move in regard to their angle with the sun (represented on the Annular Celestial Display 102 by the sun divot 103, which is fixed on the OIS of the Annular Celestial Display 102). However, an Annulet can solve such issues by enabling placement of a representation of the moon at any position on the Annular Celestial Display 102, which can facilitate placement of a sphere representing the moon at apogee further from the earth divot 104 than the divots of the divot arrangement 130 fixed on the Annular Celestial Display 102. Conversely, an Annulet representing the moon at perigee could be placed closer to the earth divot 104 than the divots of the divot arrangement 130 fixed on the Annular Celestial Display 102 (in some situations, a set of Annulets can be used to transform any surface into an Annulus, replacing divots entirely if the user understands how to arrange them).

In some implementations, an Annulus can comprise divots of different sizes, and the sizes of the divots can convey various information. For example, on the Annular Celestial Display 102 of FIG. 1, divots 105 (representing 0° separation from the sun divot 103 relative to the earth divot 104), 106 and 112 (representing 45° separation from the sun divot 103 relative to the earth divot 104), 107 and 111 (representing 90° separation from the sun divot 103 relative to the earth divot 104), 108 and 110 (representing 135° from the sun divot 103 relative to the earth divot 104), and 109 (representing 180° From the sun divot 103 relative to the earth divot 104) are larger than other divots, which can assist users in quickly finding these angles (which correspond to the 8 major phases of the moon). As another example, the sizes of the divots could be used to indicate other information, such as by implementing larger divots at and near the 180° position or the full moon position (e.g., at or near divot 109) and/or implementing smaller divots at and near the 0° position or new moon position (e.g., at or near divot 105), which can allow the divots to convey the relative brightness of the moon at the noted phases.

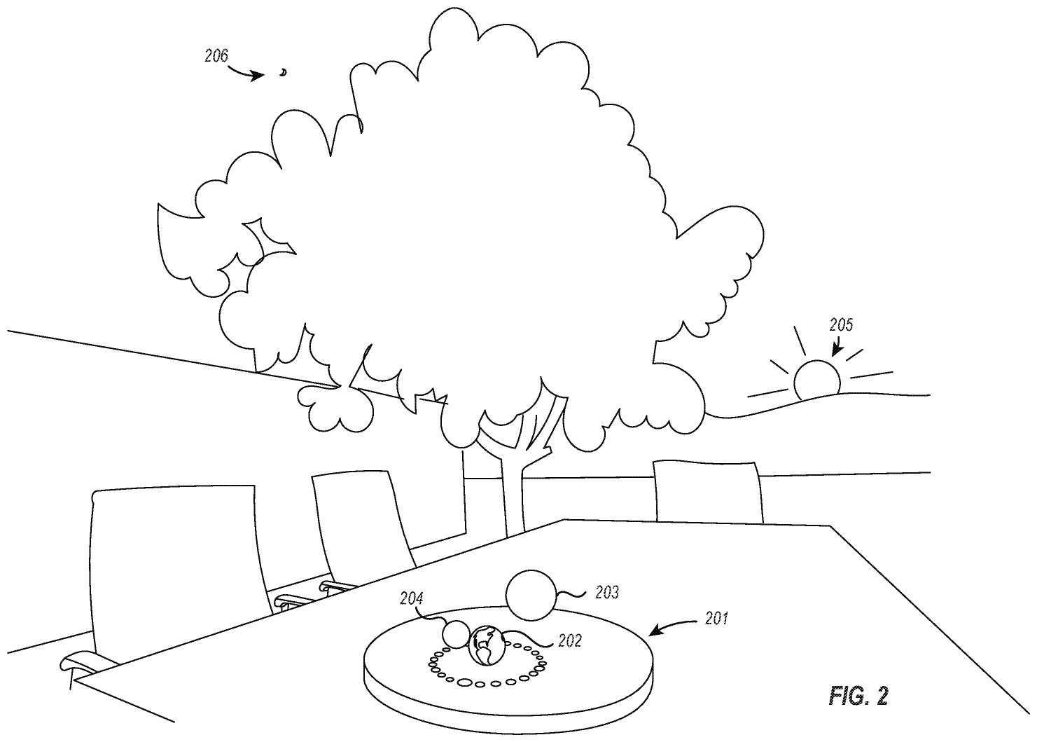

FIG. 2 shows an Annular Celestial Display system that includes an Annular Celestial Display 201 (corresponding to Annular Celestial Display 102 of FIG. 1), an earth object 202 (e.g., a sphere representing the earth, positioned in FIG. 2 on an earth divot of the Annular Celestial Display 201 corresponding to the earth divot 104 of the Annular Celestial Display 102 of FIG. 1), a sun object 203 (e.g., a sphere representing the sun, positioned in FIG. 2 on a sun divot of the Annular Celestial Display 201 corresponding to the sun divot 103 of the Annular Celestial Display 102 of FIG. 1), and a moon object 204 (e.g., a sphere representing the moon, positioned in FIG. 2 on a divot of a divot arrangement of the Annular Celestial Display 201 that represents the moon's orbit, corresponding to the divot arrangement 130 of the Annular Celestial Display 102 of FIG. 1). Objects used to represent celestial bodies/objects in conjunction with an Annulus can comprise any suitable material. FIG. 2 depicts a moment in time captured by photograph on Aug. 2, 2022, at 7:24 PM in Los Angeles, California. In the example shown in FIG. 2, the Annular Celestial Display 201 has been positioned so that the sun object 203 is oriented toward the position of the sun 205 in the sky (e.g., just above the western horizon). The moon object 204 is positioned on a divot of the Annular Celestial Display 201 that represents a 60° separation between the sun and the moon (e.g., referring to FIG. 1, one divot counterclockwise from divot 106 on the divot arrangement 130), sometimes referred to as a sextile occurring on the 5th day following the previous new moon. As shown in FIG. 2, the position of the moon object 204 on the Annular Celestial Display 201 is oriented toward the position of the moon 206 in the sky. Other moments in time can be represented via an OIS of an Annulus system (or Annular Celestial Display system), with the objects on the Annulus being aligned with respective celestial objects in the sky.

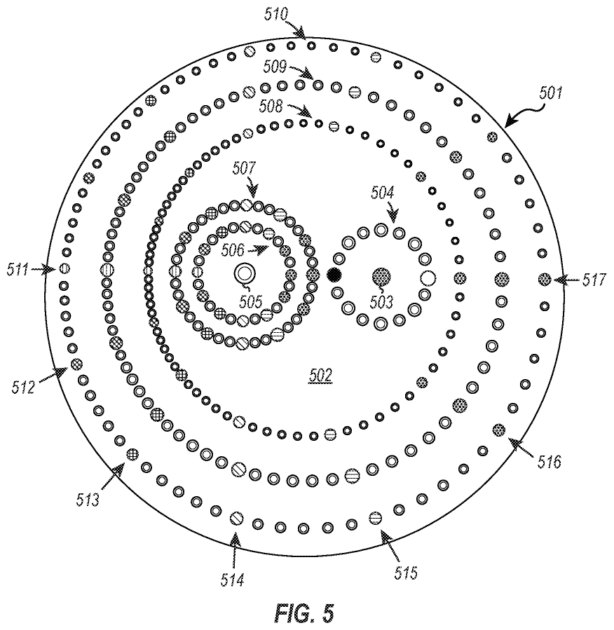

FIG. 5 shows an alternative embodiment of an OIS of an Annular Celestial Display 502, which includes a circular border 501, a star divot 505 (e.g., representing the sun), and orbit divots 506 and 507 arranged around the star divot 505, which may represent the orbits of inferior planets (e.g., Mercury and Venus, respectively) about the star divot 505 relative to a planet divot 503 (e.g., representing the earth). The Annular Celestial Display 502 also includes orbit divots 504 arranged around the planet divot 503 (e.g., representing the orbit of the earth's moon). The Annular Celestial Display 502 also includes orbit divots 508, 509, and 510 arranged around both the star divot 505 and the planet divot 503, which may represent the orbits of superior planets (e.g., Mars, Jupiter, and Saturn, respectively) about the star divot 505 relative to the planet divot 503. The example OIS of the Annular Celestial Display 502 depicts each of the planets consistently visible from the earth. Other embodiments can include orbit divots for other celestial bodies, such as Uranus and Neptune, an asteroid, the Kuiper Belt, and/or others. The positioning of an object representing a planet (or other celestial object) along its respective orbit divots can provide information about its phase and time of day when and where it is visible. The OIS of an Annulus may include any of the foregoing variations, or combinations thereof.

While an Annulus may omit inset lines, divots that are a part of at least some of the orbit divots for celestial objects can be arranged/aligned along rays that extend inward to or outward from the star divot 505.

As noted above, additional information can be incorporated into an Annulus through the size of the divots. For example, each of the orbit divots can be differentiated from one another by implementing larger divots for larger planets (e.g., larger divots for orbits of planets like Jupiter or Saturn; smaller divots for orbits of planets like Mars or Mercury. In some instances, the sizes of divots within a set of orbit divots can be differentiated from one another, with divots representing certain angles from the star divot 505 relative to the planet divot 503 being made large to assist users in quickly finding such angles. For example, such a sizing pattern could be implemented the Annular Celestial Display 502 of FIG. 5 at divots located at the 0° position (e.g., divots along ray 511 toward the star divot 505), the 30° position (e.g., divots along ray 512 toward the star divot 505), the 60° position (e.g., divots along ray 513 toward the star divot 505), the 90° position (e.g., divots along ray 514 toward the star divot 505), the 120° position (e.g., divots along ray 515 toward the star divot 505), the 150° position (e.g., divots along ray 516 toward the star divot 505), and the 180° position (e.g., divots along ray 517 toward the star divot 505).

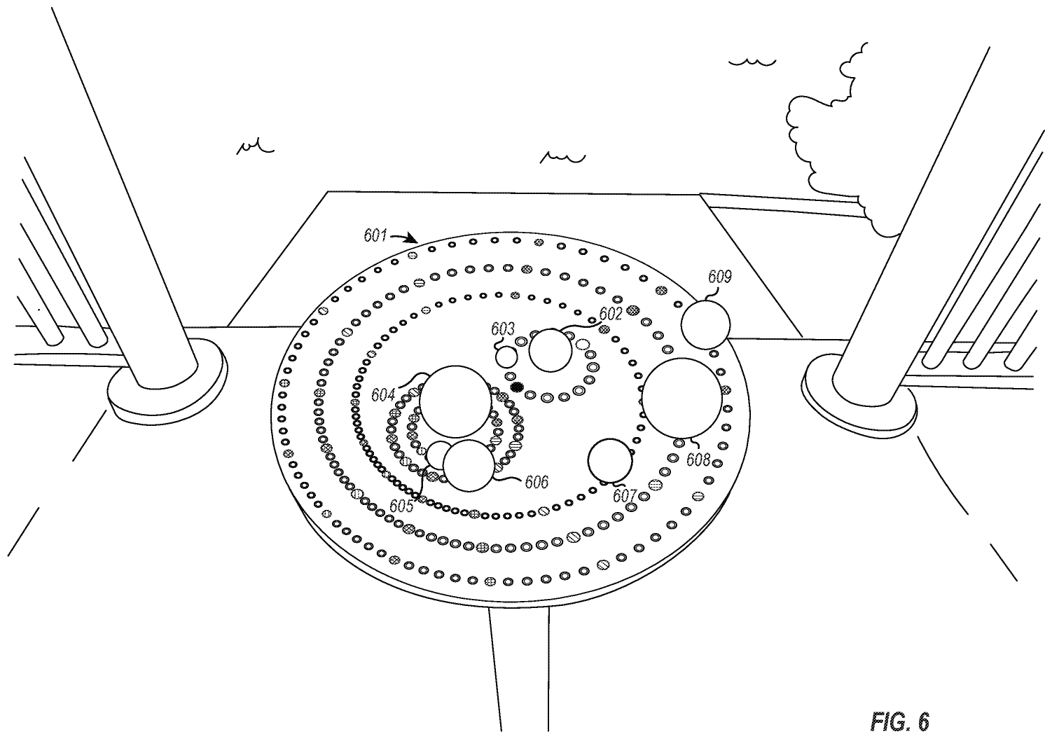

In FIG. 6, an embodiment of the Outside-In Side of an Annular Celestial Display system including an Annular Celestial Display 601 (e.g., corresponding to the Annular Celestial Display 502 of FIG. 5), an earth object 602 (e.g., a sphere representing the earth, positioned in FIG. 6 on a planet divot of the Annular Celestial Display 601 corresponding to the planet divot 503 of the Annular Celestial Display 502 of FIG. 5), a moon object 603 (e.g., a sphere representing the moon, positioned in FIG. 6 on an orbit divot representing the moon's orbit, corresponding to the orbit divots 504 of the Annular Celestial Display 502 of FIG. 5), a sun object 604 (e.g., a sphere representing the sun, positioned in FIG. 6 on a star divot of the Annular Celestial Display 601 corresponding to the star divot 505 of the Annular Celestial Display 502 of FIG. 5), a Mercury object 605 (e.g., a sphere representing Mercury, positioned in FIG. 6 on an orbit divot representing Mercury's orbit, corresponding to the orbit divots 506 of the Annular Celestial Display 502 of FIG. 5), a Venus object 606 (e.g., a sphere representing Venus, positioned in FIG. 6 on an orbit divot representing Venus's orbit, corresponding to the orbit divots 507 of the Annular Celestial Display 502 of FIG. 5), a Mars object 607 (e.g., a sphere representing Mars, positioned in FIG. 6 on an orbit divot representing Mars's orbit, corresponding to the orbit divots 508 of the Annular Celestial Display 502 of FIG. 5), a Jupiter object 608 (e.g., a sphere representing Jupiter, positioned in FIG. 6 on an orbit divot representing Jupiter's orbit, corresponding to the orbit divots 509 of the Annular Celestial Display 502 of FIG. 5), and a Saturn object 609 (e.g., a sphere representing Saturn, positioned in FIG. 6 on an orbit divot representing Saturn's orbit, corresponding to the orbit divots 510 of the Annular Celestial Display 502 of FIG. 5).

The Annular Celestial Display 601 of the Annular Celestial Display system shown in FIG. 6 is arranged to display a theoretical configuration of planets, referred to by astrologers as the Thema Mundi, where the moon object 603 is placed on a divot corresponding to its waning crescent phase (on the left side of the earth as shown in FIG. 6) depicting the moon is rising in the east at 15° Cancer, the sun object 604 is positioned to represent 15° Leo rising in the early morning before dawn, the mercury object 605 is placed 30° ahead of the sun on its orbit to represent 15° Virgo, the Venus object 606 is placed 60° ahead of the sun on its orbit to represent 15° Libra, the Mars object 607 is placed 90° ahead of the sun on its orbit to represent 15° Scorpio, the Jupiter object 608 is placed 120° ahead of the sun on its orbit to represent 15° Sagittarius, and the Saturn object 609 is placed 150° ahead of the sun on its orbit to represent 15° Capricorn. Ancient Hellenistic astrology placed high importance on this chart due to each planet being regarded as its own domicile or home sign.

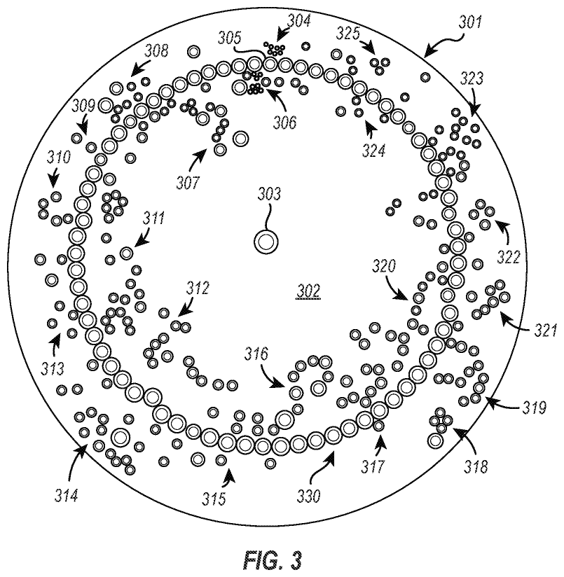

FIG. 3 illustrates an Inside-Out Side (“IOS”) of an Annular Celestial Display 302. The Annular Celestial Display 302 can correspond to any other Annulus described herein. For instance, an Annulus can comprise an OIS on one side thereof and an IOS on the other side thereof. In the example shown in FIG. 3, the IOS of the Annular Celestial Display 302 includes a planet divot 303, which can represent the planet or other celestial body/object that defines the perspective of the observer (e.g., from which the observer looks outward). The planet divot 303 can represent either the north pole or the south pole of the planet (or other celestial body/object) from which the observer looks outward from the planet. The planet divot 303 of FIG. 3 represents the south pole of the earth. The Annular Celestial Display 302 also includes ecliptic divots 330 that surround the planet divot 303, which represent possible locations (or ecliptic positions) of a star (or other celestial object) about which the planet associated with the planet divot 303 orbits (from the perspective of an observer on the planet). The ecliptic divots 330 can include any number of divots. For example, in the example of FIG. 3 where the planet divot 303 represents the earth with a 365-day orbit around the sun, including 72 divots in the ecliptic divots 330 would give each divot a temporal window of about 5 calendar dates (e.g., due to the sun moving about 1° per day through the sky from the perspective of an observer on the earth). As another example, including 36 divots in the ecliptic divots 330 would give each divot a window of about 10° (sometimes referred to as a decan). For a different example, where the planet divot 303 represents Mars with a 687-day orbit around the sun, including 72 divots in the ecliptic divots 330 would give each divot a window of about 9.5°.

The outer border 301 of the Annular Celestial Display 302 of FIG. 3 can be regarded as representing the north pole of the earth (which can be another example of warping, but such an arrangement can allow the ecliptic path of the sun and planets to appear the least warped, which can be useful due to this space containing the positions of the celestial bodies which move through the sky over time).

The IOS of the Annular Celestial Display 302 shown in FIG. 3 can retain the aforementioned function of the OIS (discussed hereinabove with reference to the Annular Celestial Display 102 of FIG. 1) of representing time similar to a clock by depicting noon when a user places an object representing the sun (or other star) onto a divot of the ecliptic divots 330 and positions the Annular Celestial Display 302 such that the object representing the sun is furthest from the user. Time passage corresponding to a day can be accomplished by a clockwise revolution of the Annular Celestial Display 302.

In contrast to the calendar representation functionality for the OIS (discussed hereinabove with reference to the Annular Celestial Display 102 of FIG. 1), the IOS of the Annular Celestial Display 302 shown in FIG. 3 can instead represent a year by moving an object representing the sun through all of the divots on the ecliptic divots 330 counterclockwise until the object has returned to its starting divot (e.g., rather than rotating the Annular Celestial Display 302 itself).

On the IOS of the Annular Celestial Display 302 shown in FIG. 3, additional divots may be arranged about the ecliptic divots 330 to represent more distant and stationary fixed-stars (referred to herein as “distant star divots”). Distant stars that appear closer to the direction of the planet's pole represented by the planet divot 303 are depicted by distant star divots placed closer (e.g., in closer proximity) to the planet divot 303 on the IOS of the Annular Celestial Display 302 (e.g., closer to the center of the Annular Celestial Display 302). In contrast, distant stars that appear further from the planet's pole represented by the planet divot 303 are depicted by distant star divots placed further from the planet divot 303 on the IOS of the Annular Celestial Display 302 (e.g., closer to the outer border 301 or circumference of the Annular Celestial Display 302). The brightness of a distant star (according to an observer on the planet represented by the planet divot 303) can be depicted on the IOS of the Annular Celestial Display 302 by the size of the distant star divots. Distant star divots that are close enough to the ecliptic divots 330 can replace divots of the ecliptic divots 330 (such distant star divots can be differentiated by size or alignment with respect to other ecliptic divots 330).

In the example shown in FIG. 3, since the distant or fixed stars move slowly (both in relation to one another in space and in relation to the ecliptic), having an object representing the sun (or another nearby star) on one particular divot of the ecliptic divots 330 can communicate a specific window of calendar dates based on the context of stars surrounding the object representing the sun. In one illustrative example, if the object representing the sun is placed on divot 305 of the ecliptic divots 330 (called the “Golden Gate of the Ecliptic,” which is between the asterisms called the Pleiades and the Hyades in Taurus, represented by distant star divots 304 and 306, respectively), an observer can know that the IOS of the Annular Celestial Display 302 displays the dates of May 21-26 2020 AD (which would remain consistent for the lifespan of an individual person, give or take a day; though the procession of the equinoxes would cause shifts over long time periods; e.g., if an Annulus was made 4500 years ago when the Tal-Qadi Sky Tablet was constructed, the sun would have been on E1 during the northern equinox, what we would modernly call March 20-25th).

The IOS of the Annular Celestial Display 302 of FIG. 3 also displays many other constellations including Orion (represented by distant star divots 307), Gemini (represented by distant star divots 308), Cancer (represented by distant star divots 309), Hydra (represented by distant star divots 310), Leo (represented by distant star divots 311), Corpus and Crater (represented by distant star divots 312), Virgo (represented by distant star divots 313), Bootes (represented by distant star divots 314), Libra (represented by distant star divots 315), Scorpio (represented by distant star divots 316), Sagittarius (represented by distant star divots 317), Lyra (represented by distant star divots 318), Aquila (represented by distant star divots 319), Capricorn (represented by distant star divots 320), Delphinus (represented by distant star divots 321), Aquarius (represented by distant star divots 322), Pegasus (represented by distant star divots 323), Pisces (represented by distant star divots 324), and Aries (represented by distant star divots 325). The divots upon an Inside-Out Side embodiment of an Annulus could display any combination of stars, asterisms, or constellations.

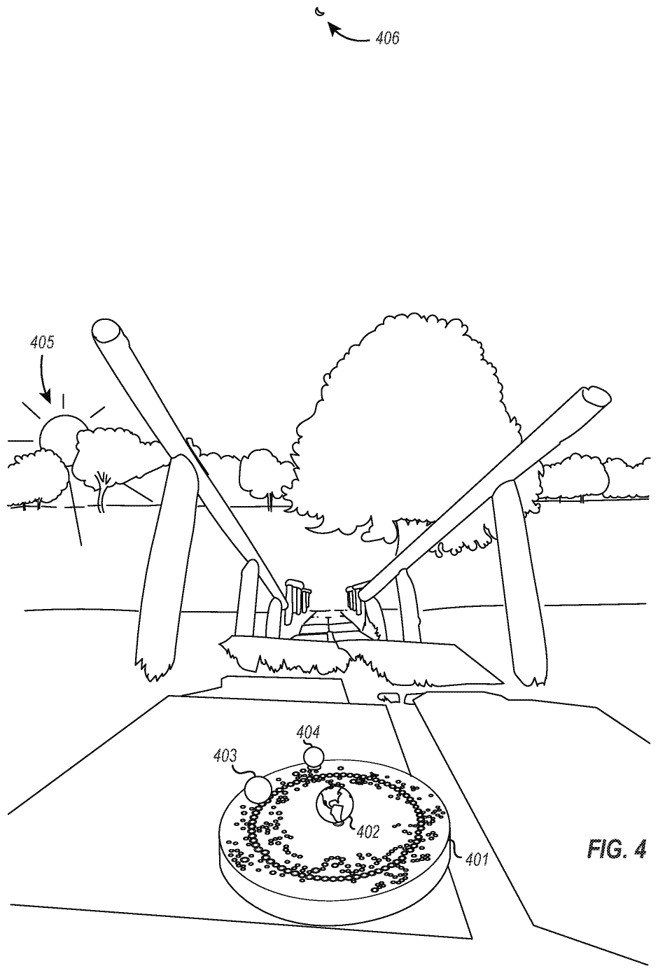

FIG. 4 shows an Annular Celestial Display system that includes an IOS of an Annular Celestial Display 401 (e.g., corresponding to the Annular Celestial Display 302 of FIG. 3), an earth object 402 (e.g., a sphere representing the earth, positioned in FIG. 4 on a planet divot of the Annular Celestial Display 401 corresponding to the planet divot 303 of the Annular Celestial Display 302 of FIG. 3) and a sun object 403 (e.g., a sphere representing the sun, positioned in FIG. 4 near alignment with the distant star Regulus or Alpha Leonis, occurring near August 20 every year in the 21st century, on an ecliptic divot E19 of the ecliptic divots of the Annular Celestial Display 401, which correspond to the ecliptic divots 330 of the Annular Celestial Display 302 of FIG. 3). FIG. 4 depicts a moment in time captured by photograph on Aug. 21, 2022, at 5:39 AM in Sheboygan, Wisconsin. In the example shown in FIG. 4, the Annular Celestial Display 401 has been positioned so that the sun object 403 is oriented toward or aligned with the position of the sun 405 in the sky (e.g., at the eastern horizon at sunrise). The Annular Celestial Display system also includes a moon object 404 (e.g., a sphere representing the moon) that is placed north of the constellation of Orion and E7, and which is also oriented toward or aligned with the position of the moon 406 in the sky. In the example shown, the Annular Celestial Display 401 lacks a divot or other position indicator at the position occupied by the moon object 404 so an Annulet is used to retain the moon object 404 at its position. The moon does not follow the ecliptic like the sun, instead rising north and south of the sun's ecliptic over the course of each month, so an Annulet can be used to accurately show the position of the moon on the IOS of an Annulus. In the example shown, the moon object 404 is positioned 12 divots (along the ecliptic divots) behind the sun object 403, representing 60° or a waning crescent phase. Though FIG. 4 depicts a specific moment of space time, the arrangement shown could represent any day where the sun, moon, and earth are at such an angular relationship, a configuration which occurs roughly every year. In this regard, an Annulus system can be set up on its IOS to display a specific moment in which the angles of the objects depicting celestial bodies are aligned with the positions of the celestial bodies in the sky.

Divots inset upon an Annulus may be neutral, colored-in, or otherwise differentiated to show various qualities of the divot. This might be accomplished through markers, paint, or any other method. Divots may also be filled with other objects, such as rhinestones, for a more opulent effect. Though filling the divot can mitigate the usefulness of the divot for setting spheres or other objects thereon, in some instances, not every divot on the Annulus is utilized for this purpose, such as for distant star divots as described hereinabove. If a user desires to place a sphere in the location of a divot filled with a rhinestone, they may do so by using an Annulet.

One will appreciate, in view of the present disclosure, that the specific examples of an Annulus shown herein may be varied within the scope of the present disclosure. For instance, the Annular Celestial Display 102 of FIG. 1 may be modified to omit a divot arrangement 130 representing an orbit of a moon, focusing on the relationship between two celestial objects (e.g., a star and a planet, or any others). As another example, the Annular Celestial Display 302 of FIG. 3 may be modified to omit distant star divots 304, focusing on the relationship between the planet divot 303 (which can represent any type of celestial object) and an ecliptic.

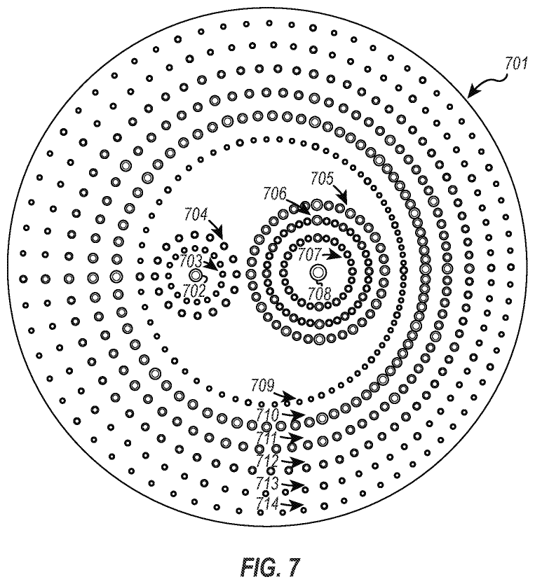

Although the foregoing examples related to an Annulus providing perspectives relating to the earth (e.g., a geocentric perspective), the principles described herein are in no way limited to this reference point. For instance, FIG. 7 shows an OIS of an Annular Celestial Display 701 that is arranged to display the point of view from an observer on Mars via a Mars divot 702, with two moons (the orbits of which are represented by orbit divots 703 and 704), and with the earth (represented by orbit divots 705) and Venus (represented by orbit divots 706) and Mercury (represented by orbit divots 707) orbiting the sun (represented by sun divot 708) with inferior orbits. Additional orbit divots nearer to the circumference of the Annular Celestial Display 701 include orbits for the Asteroid Belt (represented by orbit divots 709), Jupiter (represented by orbit divots 710), Saturn (represented by orbit divots 711), Uranus (represented by orbit divots 712), Neptune (represented by orbit divots 713), and the Kuiper Belt (represented by orbit divots 714).

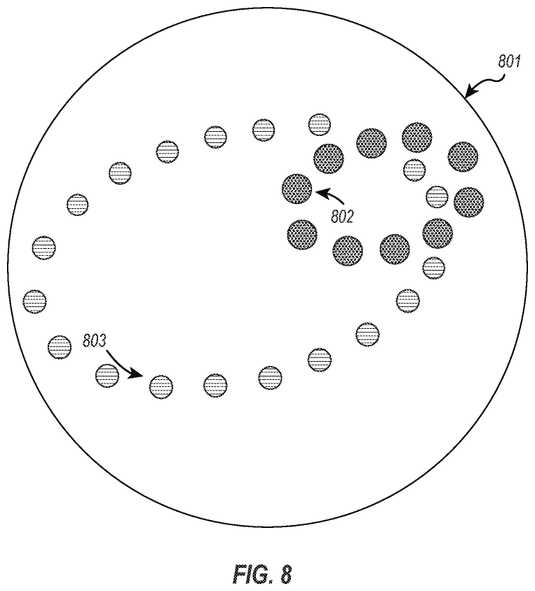

Other embodiments could also be arranged around different star-systems entirely, displaying the orbit of the various planets in orbit around said stars, or the unique arrangement of fixed or distant stars as observed from their position in space. FIG. 8 displays the OIS of an Annular Celestial Display 801 that represents binary stars of Alpha Canis Majoris, or Sirius, the brightest of any fixed or distant star in the night sky. The orbit of the more massive and bright main-sequence star Sirius is represented by orbit divots 802 (which are larger), while the orbit of the smaller and dimmer white dwarf companion Sirius B is represented by orbit divots 803 (which are smaller). The two complete their orbits around one another in around 50 Earth-Years. Additional or alternative embodiments could be constructed around any stellar system and may include planets in orbit of stars.

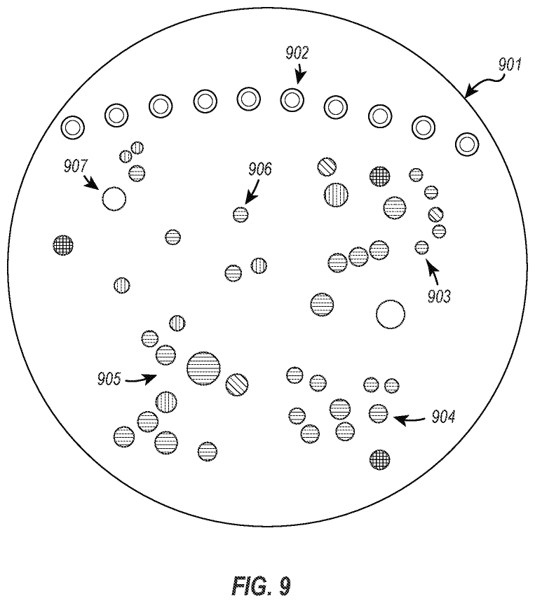

FIG. 9 shows an Annular Celestial Display 901 that shows a small section of the northern-most part of the ecliptic represented by divots 902, and a selection of constellations south of it, including Canis Majoris (represented by distant star divots 905), where Sirius sits in its throat as its brightest star. The time of year during which the sun passed Sirius, and the brightest star made its helical rise, becoming visible before the sun at dawn, was a very important calendar event for the ancient Egyptian civilization (as it correlated with the flooding of the Nile River). In Greek mythology, the stories of the hunter Orion (represented by distant star divots 903), his larger dog (Canis Major, represented by distant star divots 905), and his smaller dog (Canis Minor, represented by distant star divots 907) are derived from these stars, chasing the rabbit called Lepus (represented by distant star divots 904), nearby a dimmer unicorn, Monoceros (represented by distant star divots 906). Embodiments of the IOS of an Annulus may zoom in on parts of the sky to emphasize different features similar to the manner shown in FIG. 9.

The design of an Annulus can additionally venture outside the constraints of reality and into the realm of fiction. It need not stick to the measurable, scientific arrangements of observable celestial systems, but instead can be produced creatively to construct and display the layout of imaginary places, such as the setting of a science-fiction novel. Using the same fundamental mechanics of how stellar systems form and proceed in the vast majority of cases in the universe, an Annulus can render an artistic interpretation of the skies from a planet which is constructed creatively, to enhance the storytelling.

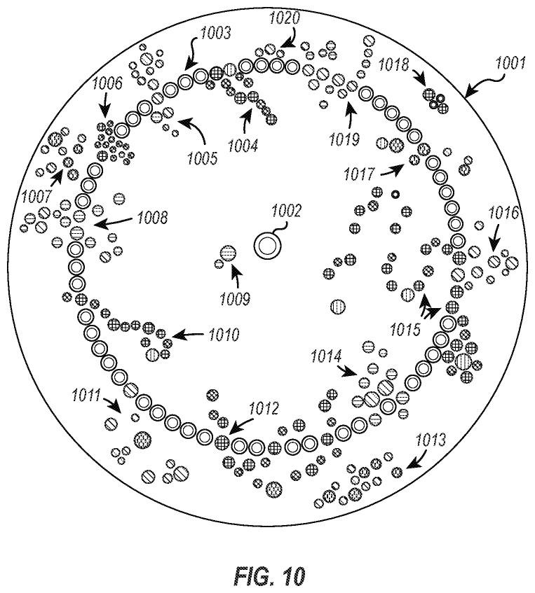

FIG. 10 displays an IOS embodiment of an Annular Celestial Display 1001 designed to feature the sky as seen from the planet Arrakis (represented by planet divot 1002), the setting of the “Dune” series by Frank Herbert. The ecliptic divots 1003 represent the path of the star Canopus, around which Arrakis orbits, in the canon of the story. The ecliptic divots 1003 run through a near-fully fabricated series of constellations, using images unique to the narrative of the novel, selected with regards to the cultural perspective of the Fremen people, the natives who live on Arrakis, who would group and name the stars in this sky. The only constellation mentioned in the first novel is studied by Paul's mother Jessica, looking at a picture of “‘Muad'Dib: The Mouse [(represented by distant star divots 1019)],’ and noted that the tail pointed north.” The other stellar description is given in Children of Dune. As Leto II travels the desert alone, he “searched for the constellation of the Wanderer [(represented by distant star divots 1012)], found it, and let his gaze follow the outstretched arm to the brilliant glittering of Foum Al-Hout [(represented by distant star divots 1009)], the polar star of the south.” The Annular Celestial Display 1001 of FIG. 10 also shows additional constellations, including Sandtrout (represented by distant star divots 1004) Saguaro (represented by distant star divots 1005), Spice-blast Nebula (represented by distant star divots 1006), Desert Hawk (represented by distant star divots 1007), Reverend Mother “Sayyadina” (represented by distant star divots 1008), Little Maker (represented by distant star divots 1010), Distrans Bat (represented by distant star divots 1011), Sand-storm (represented by distant star divots 1013), Desert Owl (represented by distant star divots 1014), Great Worm “Shai Hulud” (represented by distant star divots 1015), Fremen “Steersman” (represented by distant star divots 1016), Crysknife (represented by distant star divots 1017), Biting Wasp (represented by distant star divots 1018), and Dewdrop (represented by distant star divots 1020). Two Moons are said to orbit Arrakis, so 3 spheres for the star Canopus, the Moons Krelln and Arvon might be used upon this Annulus, in addition to the other planets in the system.

The more details about an author's constructed world are thought of and shared, the more thoroughly an Annulus' design for that literature, or other media, may embody the canonized elements.

An Annulus may have any size diameter and may comprise any shape. On the smaller end, it may be constructed as a pendant, or something to be worn or held in the hand. It may be the size of a clock or sundial, able to sit on a desk or table, upon a wall, or fit within a backpack. It may be the size of a room, functioning as an installation in a science center or observatory. It may be mounted on the ceiling of a cathedral-like structure. An Annulus may be the size of a park, with people able to take a stroll upon its surface. This size would be especially beneficial for embodying a greater sense of proportion and scale, with the vast distances between planetary orbits more accurately displayed.

Embodiments disclosed herein can include those in the following numbered clauses:
Clause 1. A celestial display, comprising: a base; and a plurality of position indicators arranged on the base, the plurality of position indicators comprising: a star position indicator; and a planet position indicator representing a planet that orbits a star represented by the star position indicator, wherein the planet position indicator and the star position indicator are arranged along a bisector line of the base, wherein the planet position indicator and the star position indicator are offset from a center of the base on opposite sides of the center of the base, wherein: rotational positions of or about the base are each associated with a respective time of day relative to the planet, and for each rotational position of or about the base, the star position indicator and the planet position indicator indicate a position of the star relative to an observer on the planet at the respective time of day.
Clause 2. The celestial display of clause 1, wherein the base comprises a board with a circular shape.
Clause 3. The celestial display of clause 1, wherein the bisector line comprises a line of symmetry of the base.
Clause 4. The celestial display of clause 1, wherein the center of the base comprises a rotation axis of the base.
Clause 5. The celestial display of clause 1, wherein at least some position indicators of the plurality of position indicators comprise divots engraved into the base.
Clause 6. The celestial display of clause 5, wherein at least some of the divots comprise different sizes.
Clause 7. The celestial display of clause 5, wherein the divots are configured to receive and retain objects representing the star and the planet when the base is horizontally positioned.
Clause 8. The celestial display of clause 1, wherein the plurality of position indicators further comprises a plurality of orbit position indicators arranged around the planet position indicator, wherein: each of the plurality of orbit position indicators represents a phase of a moon that orbits the planet, and for each rotational position of the base, each of the plurality of orbit position indicators indicates a respective position of the moon relative to an observer on the planet at the respective time of day.
Clause 9. The celestial display of clause 8, wherein the plurality of position indicators further comprises at least an additional plurality of orbit position indicators.
Clause 10. The celestial display of clause 9, wherein the additional plurality of orbit position indicators is positioned around the star position indicator, wherein each of the additional plurality of orbit position indicators represents a phase of an inferior planet that orbits the star, and wherein, for each rotational position of the base, each of the additional plurality of orbit position indicators indicates a respective position of the inferior planet relative to the observer on the planet at the respective time of day.
Clause 11. The celestial display of clause 9, wherein the additional plurality of orbit position indicators is positioned around the star position indicator and the planet position indicator, wherein each of the additional plurality of orbit position indicators represents a phase of a superior planet that orbits the star, and wherein, for each rotational position of the base, each of the additional plurality of orbit position indicators indicates a respective position of the superior planet relative to the observer on the planet at the respective time of day.
Clause 12. A celestial display, comprising: a base; and a plurality of position indicators arranged on the base, the plurality of position indicators comprising: a planet position indicator representing a pole of a planet that orbits a star; a plurality of ecliptic position indicators arranged around the planet position indicator, wherein each of the plurality of ecliptic position indicators is associated with a respective ecliptic position of the star relative to an observer on the planet; and a plurality of distant star position indicators arranged about the plurality of ecliptic position indicators, wherein each of the plurality of distant star position indicators represents a respective distant star visible from the planet, and wherein proximity of a distant star position indicator of the plurality of distant star position indicators to the planet position indicator on the base indicates a closeness of the respective distant star to the pole of the planet.
Clause 13. The celestial display of clause 12, wherein the planet position indicator is arranged on a center of the base.
Clause 14. The celestial display of clause 12, wherein an outer border of the base represents an opposite pole of the planet.
Clause 15. The celestial display of clause 14, wherein the plurality of distant star position indicators comprises: at least some distant star position indicators arranged between the plurality of ecliptic position indicators and the planet position indicator, and at least some distant star position indicators arranged between the plurality of ecliptic position indicators and the outer border of the base.
Clause 16. The celestial display of clause 12, wherein at least some position indicators of the plurality of position indicators comprise divots engraved into the base. 17.
Clause 17. The celestial display of clause 16, wherein the divots are configured to receive and retain objects representing the star and the planet when the base is horizontally positioned.
Clause 18. A celestial display system, comprising: a celestial display, comprising: a board, comprising: a first side, comprising: a first plurality of position indicators arranged on the first side, the first plurality of position indicators comprising: a first star position indicator; and a first planet position indicator representing a planet that orbits a star represented by the first star position indicator, wherein the first planet position indicator and the first star position indicator are arranged along a bisector line of the first side of the board, wherein the first planet position indicator and the first star position indicator are offset from a rotation axis of the board on opposite sides of the rotation axis of the board, wherein: rotational positions of the board about the rotation axis are each associated with a respective time of day relative to the planet, and for each rotational position of the board, the first star position indicator and the first planet position indicator indicate a position of the star relative to an observer on the planet at the respective time of day; and a second side opposite the first side, the second side comprising: a second plurality of position indicators arranged on the second side of the board, the second plurality of position indicators comprising: a second planet position indicator representing a pole of the planet that orbits the star; and a plurality of ecliptic position indicators arranged around the second planet position indicator, wherein each of the plurality of ecliptic position indicators is associated with a respective ecliptic position of the star relative to the observer on the planet.
Clause 19. The celestial display system of clause 18, further comprising a plurality of objects representing the planet and the star, wherein at least some of the first plurality of position indicators and at least some of the second plurality of position indicators are configured to retain one or more of the plurality of objects when the board is horizontally positioned.
Clause 20. The celestial display system of clause 19, further comprising one or more rings configured for placement on the first side or the second side of the board to retain of one or more of the plurality of objects at positions that omit a position indicator of the first plurality of position indicators or the second plurality of position indicators.

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

It will also be appreciated that embodiments described herein may also include properties and/or features (e.g., ingredients, components, members, elements, parts, and/or regions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

What is claimed is:

1. A celestial display, comprising:
a base; and
a plurality of position indicators arranged on the base, the plurality of position indicators comprising:
a star position indicator; and
a planet position indicator representing a planet that orbits a star represented by the star position indicator, wherein the planet position indicator and the star position indicator are arranged along a bisector line of the base, wherein the planet position indicator and the star position indicator are offset from a center of the base on opposite sides of the center of the base, wherein:
rotational positions of or about the base are each associated with a respective time of day relative to the planet, and
for each rotational position of or about the base, the star position indicator and the planet position indicator indicate a position of the star relative to an observer on the planet at the respective time of day.

2. The celestial display of claim 1, wherein the base comprises a board with a circular shape.

3. The celestial display of claim 1, wherein the bisector line comprises a line of symmetry of the base.

4. The celestial display of claim 1, wherein the center of the base comprises a rotation axis of the base.

5. The celestial display of claim 1, wherein at least some position indicators of the plurality of position indicators comprise divots engraved into the base.

6. The celestial display of claim 5, wherein at least some of the divots comprise different sizes.

7. The celestial display of claim 5, wherein the divots are configured to receive and retain objects representing the star and the planet when the base is horizontally positioned.

8. The celestial display of claim 1, wherein the plurality of position indicators further comprises a plurality of orbit position indicators arranged around the planet position indicator, wherein:
each of the plurality of orbit position indicators represents a phase of a moon that orbits the planet, and
for each rotational position of the base, each of the plurality of orbit position indicators indicates a respective position of the moon relative to an observer on the planet at the respective time of day.

9. The celestial display of claim 8, wherein the plurality of position indicators further comprises at least an additional plurality of orbit position indicators.

10. The celestial display of claim 9, wherein the additional plurality of orbit position indicators is positioned around the star position indicator, wherein each of the additional plurality of orbit position indicators represents a phase of an inferior planet that orbits the star, and wherein, for each rotational position of the base, each of the additional plurality of orbit position indicators indicates a respective position of the inferior planet relative to the observer on the planet at the respective time of day.

11. The celestial display of claim 9, wherein the additional plurality of orbit position indicators is positioned around the star position indicator and the planet position indicator, wherein each of the additional plurality of orbit position indicators represents a phase of a superior planet that orbits the star, and wherein, for each rotational position of the base, each of the additional plurality of orbit position indicators indicates a respective position of the superior planet relative to the observer on the planet at the respective time of day.

12. A celestial display, comprising:
a base; and
a plurality of position indicators arranged on the base, the plurality of position indicators comprising:
a planet position indicator representing a pole of a planet that orbits a star;
a plurality of ecliptic position indicators arranged around the planet position indicator, wherein each of the plurality of ecliptic position indicators is associated with a respective ecliptic position of the star relative to an observer on the planet; and
a plurality of distant star position indicators arranged about the plurality of ecliptic position indicators, wherein each of the plurality of distant star position indicators represents a respective distant star visible from the planet, and wherein proximity of a distant star position indicator of the plurality of distant star position indicators to the planet position indicator on the base indicates a closeness of the respective distant star to the pole of the planet.

13. The celestial display of claim 12, wherein the planet position indicator is arranged on a center of the base.

14. The celestial display of claim 12, wherein an outer border of the base represents an opposite pole of the planet.

15. The celestial display of claim 14, wherein the plurality of distant star position indicators comprises:
at least some distant star position indicators arranged between the plurality of ecliptic position indicators and the planet position indicator, and
at least some distant star position indicators arranged between the plurality of ecliptic position indicators and the outer border of the base.

16. The celestial display of claim 12, wherein at least some position indicators of the plurality of position indicators comprise divots engraved into the base.

17. The celestial display of claim 16, wherein the divots are configured to receive and retain objects representing the star and the planet when the base is horizontally positioned.

18. A celestial display system, comprising:
a celestial display, comprising:
a board, comprising:
a first side, comprising:
a first plurality of position indicators arranged on the first side, the first plurality of position indicators comprising:
a first star position indicator; and
a first planet position indicator representing a planet that orbits a star represented by the first star position indicator, wherein the first planet position indicator and the first star position indicator are arranged along a bisector line of the first side of the board, wherein the first planet position indicator and the first star position indicator are offset from a rotation axis of the board on opposite sides of the rotation axis of the board, wherein:
rotational positions of the board about the rotation axis are each associated with a respective time of day relative to the planet, and
for each rotational position of the board, the first star position indicator and the first planet position indicator indicate a position of the star relative to an observer on the planet at the respective time of day; and
a second side opposite the first side, the second side comprising:
a second plurality of position indicators arranged on the second side of the board, the second plurality of position indicators comprising:
a second planet position indicator representing a pole of the planet that orbits the star; and
a plurality of ecliptic position indicators arranged around the second planet position indicator, wherein each of the plurality of ecliptic position indicators is associated with a respective ecliptic position of the star relative to the observer on the planet.

19. The celestial display system of claim 18, further comprising a plurality of objects representing the planet and the star, wherein at least some of the first plurality of position indicators and at least some of the second plurality of position indicators are configured to retain one or more of the plurality of objects when the board is horizontally positioned.

20. The celestial display system of claim 19, further comprising one or more rings configured for placement on the first side or the second side of the board to retain of one or more of the plurality of objects at positions that omit a position indicator of the first plurality of position indicators or the second plurality of position indicators.
